(19) United States
(12) Patent Application Publication
(10) Pub. No.: US 2009/0138959 A1
(43) Pub. Date: May 28, 2009

(54) DEVICE, SYSTEM AND METHOD FOR DROPPING ATTACK MULTIMEDIA PACKET IN THE VoIP SERVICE

(76) Inventors: Chae Tae IM, Seoul (KR); Yong Geun Won, Seoul (KR); Hwan Kuk Kim, Seoul (KR); Yoo Jae Won, Yongin-si (KR)

Correspondence Address: Charles N. J. Ruggiero;Ohlandt, Greeley, Ruggiero & Perle, L.L.P., 10th Floor, One Landmark Square, Stamford, CT, 06901-2682, US

(21) Appl. No.: 12/181,554

(22) Filed: Jul. 29, 2008

(30) Foreign Application Priority Data
Nov. 22, 2007 (KR) 10-2007-0119850

(51) Int. Cl. G06F 21/00

(52) U.S. Cl. 726/13

(57) ABSTRACT

Disclosed is a device for dropping an attack multimedia packet. An object of the invention is to provide a device, a system and a method for dropping an attack multimedia packet, capable of filtering RTP packets received to selectively drop an attack multimedia packet, thereby providing a stable multimedia service. According to the invention, the received RTP packet is filtered to selectively drop an attack multimedia packet, so that it is possible to provide a stable multimedia service.

### CROSS-REFERENCE TO RELATED APPLICATIONS

This application claims all benefits of Korean Patent Application No. 10-2007-0119850 filed on Nov. 22, 2007 in the Korean Intellectual Property Office, the disclosures of which are incorporated herein by reference.

### BACKGROUND

1. Technical Field

The present invention relates to a device, a system and a method for dropping an attack multimedia packet, and more particularly, to a device, a system and a method for dropping an attack multimedia packet, capable of effectively dropping an attack multimedia packet so as to normally provide a multimedia service using the RTP.

2. Description of the prior art

The RTP (Real-time Transport Protocol) is a transport layer protocol for transmitting/receiving voice data in real time and is performed between terminals. The RTP is typically used as an upper protocol of the UDP (User Datagram Program).

The multimedia packets for internet telephone, video communication and the like are generally transported through the RTP. While a session is set up and the RTP packets are transmitted through the SIP or H.323 protocol, an attacker may insert any RTP packet into a data stream to cause a failure in the terminal or to have an influence on a service quality.

FIG. 1 shows a RTP message format that is used to transmit multimedia contents.

The following describes each field of a RTP message format with reference to FIG. 1. V (version) indicates a version of the RTP protocol and P (padding) indicates whether the message includes a padding. X (extension) indicates whether a header is extended or not and CC (CSRC counter) indicates the number of CSRC.

M (marker) indicates a marking bit for allowing an event in a packet stream such as frame boundary and PT (payload type) indicates a RTP payload format (audio, video and the like) and can be changed at the middle of the session.

The sequence number is a number that is increased by one (1) for each RTP packet transmitted, is used to detect a packet loss and to recover a packet sequence and has any initial value.

The time stamp indicates a first octet instance sampling in the RTP data packet, is induced from the clock that is sequentially increased for the purpose of synchronization and Jitter calculation, and has any initial value.

The SSRC is a value for identifying a synchronization source, is selected as any value and is an inherent value that is used to identify the RTP stream session. The CSRC list is a list of identified values (SSRC) for a corresponding source when performing the communication with many persons (it is processed in a mixer for processing many call contents) and maximum 15 lists can be provided.

Among the RTP message field values, the SSRC is a unique value for identifying the RTP session. The time stamp and the sequence number are the important fields indicating that the transmission is made in the normal sequence and time. Hence, the above values are importantly used to determine whether the packet is arbitrarily generated by an attacker on the data stream of the RTP packets.

When an attacker transmits an attack multimedia packet for attack threat, damage is caused in the RTP packet processing system, in the form of failure of service or denial of service, for example.

When an attacker generates and transmits any RTP packet to a service using/via system, thereby giving rise to excessive traffic, the failure of service is caused. Many attack packets may be discarded in the level of the protocol or application program. However, due to the processing of many packets, the service quality may be deteriorated or the failure of service may be caused.

In the RTP insertion attack as an alternative attack type, an attacker monitors a RTP signal through the sniffing and checks the UDP port number and the SSRC (Synchronization Source), which are used by an object for which the attack is made, thereby supposing the increased value thereof. When a next session is generated, both a normal packet and a spoofed packet are generated/transmitted, during the call, to process the media traffics of the attacker, thereby interrupting the call. As the application processes the spoofed packet, the unwanted contents are reproduced or the normal packet is discarded, so that the reproduction may not be made for a predetermined period.

### SUMMARY OF THE DISCLOSURE

Accordingly, the present invention has been made to solve the above problems. An object of the invention is to provide a device, a system and a method for dropping an attack multimedia packet, capable of filtering RTP packets received to selectively drop an attack multimedia packet, thereby providing a stable multimedia service.

In order to achieve the above object, there is provided a device for dropping an attack multimedia packet. The device comprises an IP/Port blacklist that registers and manages IP/Port information that is an object for dropping; a blacklist filter that refers to the IP/Port blacklist for the IP/Port information registered therein and drops a received RTP packet when the IP/Port information conforms to an IP/Port of the received RTP packet; a non-registration session RTP packet filter that compares the IP/Port and SSRC of the RTP packet filtered in the blacklist filter with IP/Port information and SSRC information of a normal user registered, thereby selectively dropping the RTP packet; a registration session memory that provides IP/Port information and SSRC information of a normal user registered of a RTP packet having a call set normally to the non-registration session RTP packet filter; and a spoofed RTP packet filter that calculates differences between a time stamp and a sequence number of the received RTP packet and a time stamp and a sequence number of a RTP packet received just previously, thereby selectively dropping the received RTP packet, based on the calculated values.

According to an embodiment of the invention, there is provided a system for dropping an attack multimedia packet. The system comprises a transmit terminal; a receive terminal that receives a RTP packet transmitted from the transmit terminal to receive a multimedia service; a call setup device that exchanges a call initiating signal and call information between the transmit terminal and the receive terminal; and a device for dropping an attack multimedia packet that examines the RTP packet transmitted from the transmit terminal to drop a malicious RTP packet. The device for dropping an attack multimedia packet comprises an IP/Port blacklist that registers and manages IP/Port information that is an object for dropping; a blacklist filter that refers to the IP/Port blacklist for the IP/Port information registered therein and drops a received RTP packet when the IP/Port information conforms to an IP/Port of the received RTP packet; a non-registration session RTP packet filter that compares the IP/Port and SSRC of the RTP packet filtered in the blacklist filter with IP/Port information and SSRC information of a normal user registered, thereby selectively dropping the RTP packet; a registration session memory that provides IP/Port information and SSRC information of a normal user registered of a RTP packet having a call set normally to the non-registration session RTP packet filter; and a spoofed RTP packet filter that calculates differences between a time stamp and a sequence number of the received RTP packet and a time stamp and a sequence number of a RTP packet received just previously, thereby selectively dropping the received RTP packet, based on the calculated values.

According to an embodiment of the invention, there is provided a method for dropping an attack multimedia packet. The method comprises the steps of: (a) comparing an IP/Port of RTP packet received through a call setup route with IP/Port information of an attacker registered, thereby selectively dropping the received RTP packet; (b) comparing IP/Port and SSRC of the received RTP packet having passed to the step of (a), based on IP/Port and SSRC information of a normal user registered of a RTP packet received through a normal call setup route, thereby selectively dropping the RTP packet; and (c) calculating differences between a time stamp and a sequence number of the received RTP packet and a time stamp and a sequence number of a RTP packet received just previously, thereby selectively dropping the received RTP packet, based on the calculated values.

According to the invention, the received RTP packets are filtered, so that an attack multimedia packet is selectively dropped. As a result, it is possible to provide a stable multimedia service.

### BRIEF DESCRIPTION OF THE DRAWINGS

The above and other objects, features and advantages of the present invention will be more apparent from the following detailed description taken in conjunction with the accompanying drawings, in which:

FIG. 1 shows a RTP message format that is used to transmit multimedia contents;

FIG. 2 is a block diagram showing a structure of a system for dropping an attack multimedia packet according to an embodiment;

FIG. 3 is a block diagram showing a structure of a device for dropping an attack multimedia packet according to an embodiment; and

FIGS. 4a to 4c are flow charts showing method for dropping an attack multimedia packet according to an embodiment.

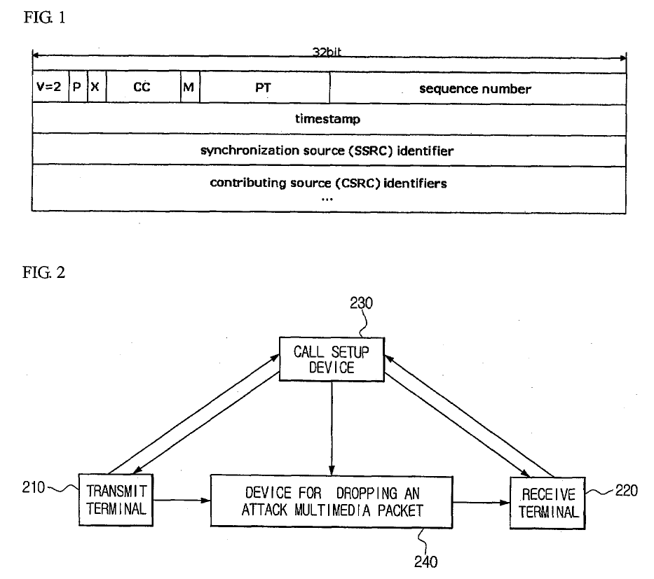

### DETAILED DESCRIPTION OF THE INVENTION

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

FIG. 2 is a block diagram showing a structure of a system for dropping an attack multimedia packet according to an embodiment.

Referring to FIG. 2, a system for dropping an attack multimedia packet comprises a transmit terminal 210, a receive terminal 220, a call setup device 230 and a device 240 for dropping an attack multimedia packet.

The transmit terminal 210 transmits a call request message to the call setup device 230 so as to provide a multimedia service to the receive terminal 220.

The call setup device 230 comprises a proxy server (not shown) that forwards the call request message to the receive terminal 220 that is an object for call.

The receive terminal 220 receives the call request message and transmits a call accepting message to the proxy server when it wants to receive the multimedia service.

The proxy server forwards the call accepting message to the transmit terminal 210. As a result, a call setup is completed, so that a route is set up which enables an actual call through RTP packets between the transmit terminal 210 and the receive terminal 220.

The device 240 for dropping an attack multimedia packet is disposed between the transmit terminal 210 and the receive terminal 220, examines RTP packets transmitted from the transmit terminal 210 to drop a malicious RTP packet. The device 240 for dropping an attack multimedia packet should have a function of proxying all the RTP packets on the transmit/receive route of the RTP packets.

Here, since the call setup route and the transmit route of the RTP packets are independent each other, the call setup device 230 goes via a specific point of the device 240 for dropping an attack multimedia packet during the call setup process so as to receive all the RTP packets. Since the device 240 for dropping an attack multimedia packet is connected with the call setup device 230 through an interface, it can receive call setup information that is set normally through the corresponding interface.

In general, since the SBC (Session Border Controller) “proxies” the RTP packets, it is possible to apply the device 240 for dropping an attack multimedia packet to front and rear ends of the SBC, or to mount the function of the device 240 for dropping an attack multimedia packet to the SBC system.

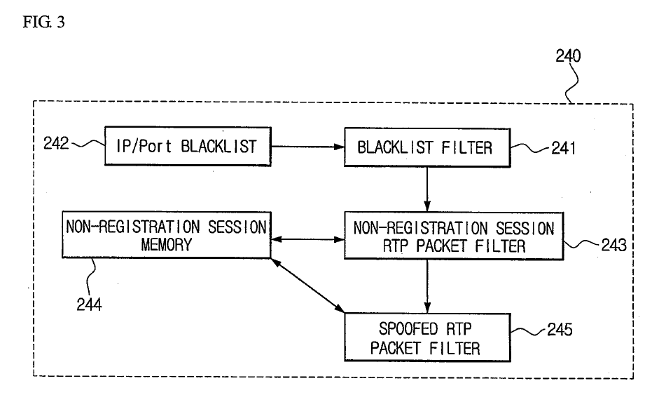

FIG. 3 is a block diagram showing a structure of a device for dropping an attack multimedia packet according to an embodiment.

Referring to FIG. 3, the device 240 for dropping an attack multimedia packet comprises a blacklist filter 241, an IP/Port blacklist 242, a non-registration session RTP packet filter 243, a registration session memory 244 and a spoofed RTP packet filter 245.

A security manager considers specific IP/Port information as an attacker and registers it in the IP/Port blacklist 242 so as to drop a malicious attack multimedia packet, based on the IP/Port information of the RTP packet.

The blacklist filter 241 compares the IP/Port information registered in the IP/Port blacklist 242 with an IP/Port of the RTP packet received and drops a RTP packet having IP/Port information conforming to the IP/Port information registered as an attacker.

The RTP packet filtered through the blacklist filter 241 passes through the non-registration session RTP packet 243. When the received RTP packet is a non-registration session RTP packet whose call is not set normally and that is arbitrarily generated by an attacker, based on the IP/Port information registered as a normal user and the SSRC information of the RTP packet, the non-registration session RTP packet filter 243 drops the corresponding packet.

Here, the non-registration session RTP packet filter 243 shares the call setup information with an equipment such as soft switch for session setup, IMS, gate keeper, SIP proxy, SBC and the like.

The registration session memory 244 receives and stores/manages the information about the call set normally from the equipment such as soft switch for session setup, IMS, gate keeper, SIP proxy, SBC and the like. The device 240 for dropping an attack multimedia packet updates and stores the sequence number and time stamp values in the registration session memory 244 whenever processing the RTP packet.

The registration session memory 244 and the non-registration session RTP packet filter 243 are connected with each other through an interface. When there is no SSRC value, as a result of referring to the registration session memory for the registration session, this may correspond to a case where a RTP session is generated and a first RTP packet is received. Accordingly, when there is no SSRC value, the non-registration session packet filter 243 does not drop the RTP packet, stores the SSRC of the RTP packet in the registration session memory 244 and forwards the RTP packet to a next process.

The spoofed RTP packet filter 245 drops a spoofed RTP packet. An attacker has acquired the RTP stream session information through the sniffing, and has generated the spoofed RTP packet to process the corresponding RTP packet in the receive terminal 220. The spoofed RTP packet filter 245 filters the spoofed RTP packet, based on the field values of the time stamp and the sequence number of the RTP packet received.

The time stamp indicates a first octet instance sampling in a RTP packet, is induced from the clock that is sequentially increased for the purpose of synchronization and Jitter calculation, and has any initial value. For example, if several continuous packets are generated at the same time in the same video frame information, these packets may have the same time stamp.

The spoofed RTP packet filter 245 refers to the registration session memory 244 for the session information registered therein so as to refer to the sequence numbers and the time stamps of the RTP packets received up to the just previous time.

Then, when a difference between the stored time stamp and the time stamp of the received RTP packet is larger than a previous increase unit, the spoofed RTP packet filter 245 drops the received RTP packet. Since the packet may be a packet that exceeds a sampling unit first step and is likely to be arbitrarily generated by an attacker, the transmission thereof is delayed for a long time, so that it may be discarded in the application layer or may be reproduced in the application program.

In the meantime, the sequence number is a number that is increased by one (1) for each RTP packet transmitted. When the sequence number deviates from a range of indicated thresholds, as compared to the stored sequence number value, or is same the sequence number of the RTP packet already received, the packet is dropped.

Although the sequence numbers may not arrive sequentially on a packet transmit route, the packet having the high extent thereof is considered as a packet that is arbitrarily generated by an attacker, so that the corresponding packet is dropped.

Among the RTP packets having passed the dropping process by the time stamp and the sequence number, a packet whose sequence number is increased but time stamp is decreased or a packet whose sequence number is decreased but time stamp is increased is considered as a packet that is arbitrarily generated by an attacker, so that the corresponding RTP packet is dropped.

As described above, the device 240 for dropping an attack multimedia packet filters the RTP packets through the blacklist filter 241, the non-registration session RTP packet filter 243 and the spoofed RTP packet filter 245, so that it can drop the RTP packet that is maliciously generated by an attacker.

The following specifically describes a method for dropping an attack multimedia packet according to the invention.

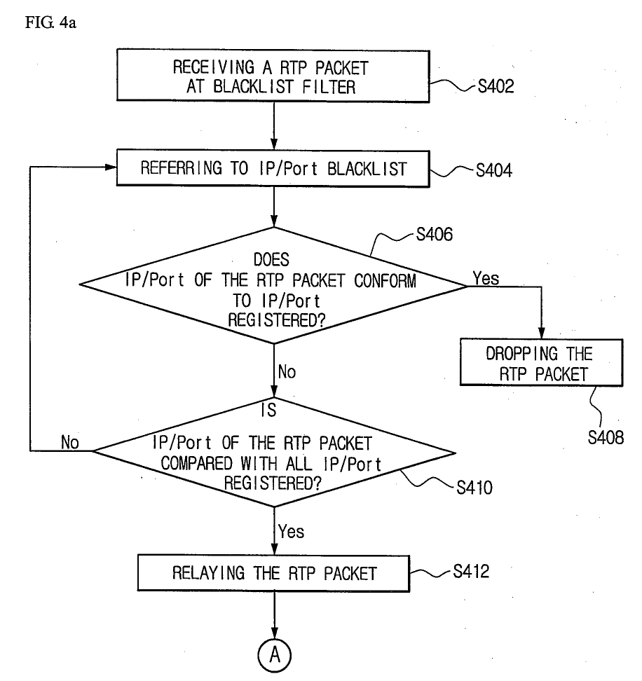

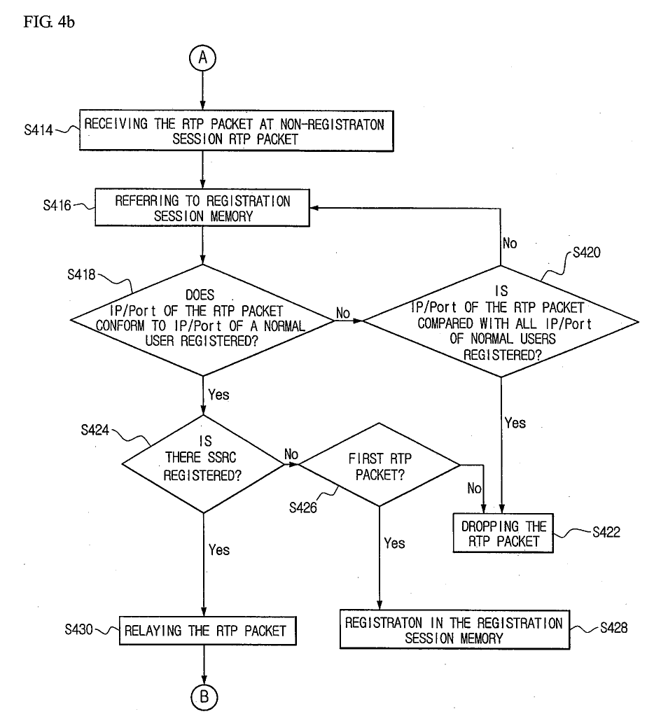

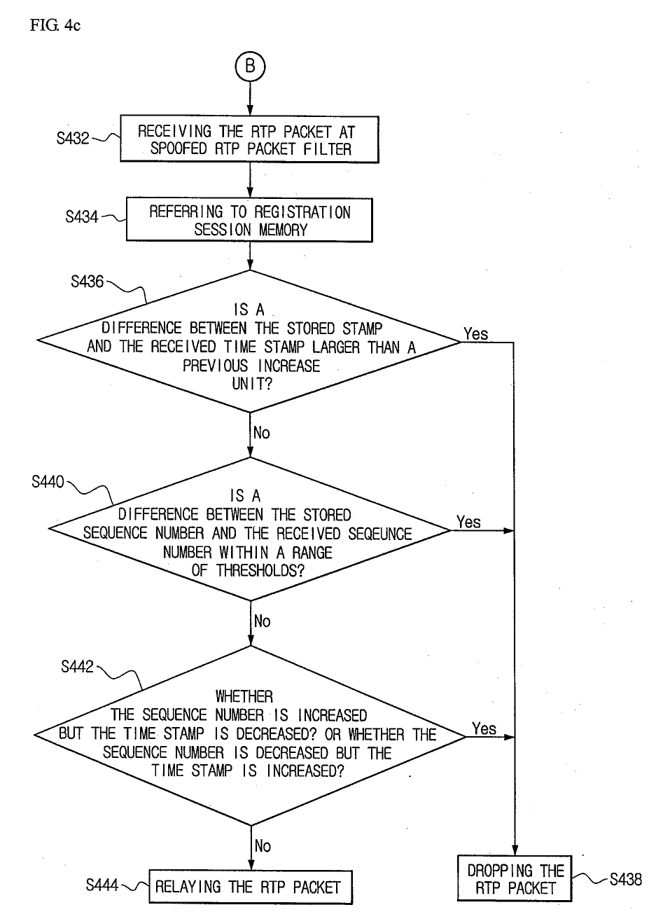

FIGS. 4a to 4c are flow charts showing method for dropping an attack multimedia packet according to an embodiment of the invention.

Referring to FIG. 4a, a RTP packet is received in the blacklist filter 241 through a call setup route (S402). The blacklist filter 241 refers to the IP/Port blacklist 242 for the IP/Port information registered as an attacker therein (S404) and compares it with the IP/Port information of the RTP packet received (S406). The specific IP/Port information may be set as a blacklist manually by a security manager or automatically by a security device such as IPS (Intrusion Prevention System).

As a result of the comparison, when the IP/Port information registered as an attacker conforms to the IP/Port information of the RTP packet received, the corresponding RTP packet is dropped (S408). The comparison is carried out for all the IP/Port information registered as an attacker in the IP/Port blacklist 242 (S410). When the IP/Port of the RTP packet received does not conform to the IP/Port information registered in the IP/Port blacklist 242, a next process continues (S412).

Referring to FIG. 4b, when the RTP packet is received in the non-registration session RTP packet filter 243 (S414), the non-registration session RTP packet filter 243 refers to the registration session memory 244 for the IP/Port registered as a normal user therein and the SSRC of the RTP packet (S416). Here, the non-registration session RTP packet filter 243 shares the call setup information that is set normally from the call setup device 230 or a call setup attack detection/drop dedicated security equipment.

Then, the non-registration session RTP packet filter checks whether the IP/Port of the RTP packet conforms to the IP/Port registered as a normal user in the registration session memory 244 (S418). When they conform to each other, a next process continues. The process of checking whether the IP/Port of the RTP packet is registered is carried out for all the IP/Port registered in the registration session memory 244 (S420).

Then, the non-registration session RTP packet filter 243 compares the SSRC information of the received RTP packet with the SSRC registered in the registration session memory 244 to check whether they conform to each other (S424). When the SSRC information of the received RTP packet conforms to the registered SSRC, a next process continues. When the SSRC information of the received RTP packet does not conform to the SSRC registered, then it is checked whether the packet is a RTP first received after a RTP session is generated (S426). When the packet is a RTP packet first received after a RTP session is generated, it is newly registered in the registration session memory 244 (S428). When the packet is not a RTP packet first received, it is dropped (S422).

Referring to FIG. 4c, when the spoofed RTP packet filter 245 receives the RTP packet (S432), the spoofed RTP packet filter 245 refers to the registration session memory 244 for the values of the sequence number and time stamp (S434). Here, the registration session memory 244 stores the values of the sequence numbers and the time stamps of the RTP packets received up to the just previous time.

Continuously, the spoofed RTP packet filter 245 calculates a difference between the stored time stamp and the time stamp of the received RTP packet (S436). When the calculated difference is larger than the previous increase unit, the spoofed RTP packet filter 245 drops the corresponding packet (S438). This is because the packet may be a packet that exceeds a sampling unit first step and is likely to be arbitrarily generated by an attacker, so that it may be partially reproduced, as described above. When the calculated difference is smaller than the previous increase unit, a next step continues, so that it is determined whether a difference between the stored sequence number and the sequence number of the received RTP packet is within a range of thresholds (S440). Although the sequence numbers may not arrive sequentially on a packet transmit route, the packet having the high extent thereof is considered as a packet that is arbitrarily generated by an attacker. Hence, when the difference deviates from the range of thresholds, the packet is considered as a spoofed RTP packet, so that the corresponding packet is dropped. When the difference is within the range of thresholds, a next step continues.

As described above, the difference values of the sequence numbers and the time stamps are calculated to filter the RTP packet. Then, among the RTP packets having passed the filtering process, it is determined whether the sequence number of the packet is increased but the time stamp thereof is decreased or whether the sequence number of the packet is decreased but the time stamp thereof is increased (S442). If so, since the packet is likely to be arbitrarily generated by an attacker, the corresponding RTP packet is dropped (S438).

When both the sequence number and the time stamp are sequentially increased or decreased together, a next step continues (S444), so that a process of transmitting the RTP packet to the receive terminal 220 is continued.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A device for dropping an attack multimedia packet comprising:
an IP/Port blacklist that registers and manages IP/Port information that is an object for dropping;
a blacklist filter that refers to the IP/Port blacklist for the IP/Port information registered therein and drops a received RTP packet when the IP/Port information conforms to an IP/Port of the received RTP packet;
a non-registration session RTP packet filter that compares the IP/Port and SSRC of the RTP packet filtered in the blacklist filter with IP/Port information and SSRC information of a normal user registered, thereby selectively dropping the RTP packet;
a registration session memory that provides IP/Port information and SSRC information of a normal user registered of a RTP packet having a call set normally to the non-registration session RTP packet filter; and
a spoofed RTP packet filter that calculates differences between a time stamp and a sequence number of the received RTP packet and a time stamp and a sequence number of a RTP packet received just previously, thereby selectively dropping the received RTP packet, based on the calculated values.

2. The device according to claim 1, wherein the registration session memory continuously stores a time stamp and a sequence number of the RTP packet having a call set normally.

3. The device according to claim 2, wherein the spoofed RTP packet filter drops the received RTP packet when the sequence number of the received RTP packet is increased but the time stamp thereof is decreased or when the sequence number of the received RTP packet is decreased but the time stamp thereof is increased.

4. The device according to claim 1, wherein the registration session memory newly registers SSRC of the received RTP packet when the IP/Port of the RTP packet received in the spoofed RTP packet filter conforms to the IP/Port registered but there is no SSRC registered.

5. The device according to claim 1, wherein the IP/Port blacklist automatically sets the IP/Port information that is an object for dropping by an intrusion prevention system (IPS).

6. A system for dropping an attack multimedia packet comprising:
a transmit terminal;
a receive terminal that receives a RTP packet transmitted from the transmit terminal to receive a multimedia service;
a call setup device that exchanges a call initiating signal and call information through a RTP packet between the transmit terminal and the receive terminal; and
a device for dropping an attack multimedia packet that examines the RTP packet transmitted from the transmit terminal to drop a malicious RTP packet,
wherein the device for dropping an attack multimedia packet comprises:
an IP/Port blacklist that registers and manages IP/Port information that is an object for dropping;
a blacklist filter that refers to the IP/Port blacklist for the IP/Port information registered therein and drops a received RTP packet when the IP/Port information conforms to an IP/Port of the received RTP packet;
a non-registration session RTP packet filter that compares the IP/Port and SSRC of the RTP packet filtered in the blacklist filter with IP/Port information and SSRC information of a normal user registered, thereby selectively dropping the RTP packet;
a registration session memory that provides the IP/Port information and the SSRC information of a normal user registered of a RTP packet having a call set normally to the non-registration session RTP packet filter; and
a spoofed RTP packet filter that calculates differences between a time stamp and a sequence number of the received RTP packet and a time stamp and a sequence number of a RTP packet received just previously, thereby selectively dropping the received RTP packet, based on the calculated values.

7. The system according to claim 6, wherein the call setup device forwards a call request message of the transmit terminal to the receive terminal and comprises a proxy server that forwards a call accepting message of the receive terminal to the transmit terminal.

8. The system according to claim 6, wherein the registration session memory continuously stores a time stamp and a sequence number of the RTP packet having a call set normally.

9. The system according to claim 8, wherein the spoofed RTP packet filter drops the received RTP packet when the sequence number of the received RTP packet is increased but the time stamp thereof is decreased or when the sequence number of the received RTP packet is decreased but the time stamp thereof is increased.

10. The system according to claim 6, wherein the registration session memory newly registers SSRC of the received RTP packet when the IP/Port of the RTP packet received in the spoofed RTP packet filter conforms to the IP/Port registered but there is no SSRC registered.

11. The system according to claim 6, wherein the non-registration session RTP packet filter shares call setup information set normally with the call setup device.

12. The system according to claim 6, wherein the IP/Port blacklist automatically sets the IP/Port information that is an object for dropping by an intrusion prevention system (IPS).

13. A method for dropping an attack multimedia packet comprising the steps of:
(a) comparing an IP/Port of RTP packet received through a call setup route with IP/Port information of an attacker registered, thereby selectively dropping the received RTP packet;
(b) comparing IP/Port and SSRC of the received RTP packet having passed to the step of (a), based on IP/Port and SSRC information of a normal user registered of a RTP packet received through a normal call setup route, thereby selectively dropping the RTP packet; and
(c) calculating differences between a time stamp and a sequence number of the received RTP packet and a time stamp and a sequence number of a RTP packet received just previously, thereby selectively dropping the received RTP packet, based on the calculated values.

14. The method according to claim 13, wherein the step of (b) comprises the steps of:
(b1) checking whether the IP/Port of the normal user registered conforms to the IP/Port of the received RTP packet and dropping the received RTP packet when they do not conform to each other;
(b2) when the IP/Port of the normal user registered conforms to the IP/Port of the received RTP packet, comparing the registered SSRC with the SSRC of the received RTP packet; and
(b3) when the SSRC of the received RTP packet does not conform to the registered SSRC, generating a RTP session, checking whether the packet is a RTP packet first received, and when the packet is a RTP packet first received, newly registering the SSRC of the received RTP packet and when the packet is not a RTP packet first received, dropping the corresponding packet.

15. The method according to claim 13, wherein the step of (c) comprises the steps of:
(c1) calculating a difference between a time stamp of the received RTP packet and a time stamp of a RTP packet received just previously and dropping the received RTP packet when the calculated difference is larger than a previous increase unit; and
(c2) determining whether a difference between a sequence number of the received RTP packet and a sequence number of a RTP packet received just previously is within a range of thresholds and dropping the received RTP packet when the difference deviates from the range of thresholds.

16. The method according to claim 15, wherein the step of (c) further comprises the step of:
(c3) comparing the received RTP packet and a RTP packet received just previously and dropping the received RTP packet when the sequence number of the packet is increased but the time stamp thereof is decreased or when the sequence number of the packet is decreased but the time stamp thereof is increased.
